(19) United States
(12) Patent Application Publication
(10) Pub. No.: US 2008/0216366 A1
(43) Pub. Date: Sep. 11, 2008

(54) Simulated Fireplace

(76) Inventors: Arthur Purton, County Louth (IE); Ronald Michael Warren, Maidenhead Berkshire (GB)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 11/922,171

(22) PCT Filed: Dec. 6, 2006
(86) PCT No.: PCT/EP2006/062900

§ 371 Date: Dec. 13, 2007

(30) Foreign Application Priority Data
Jun. 2, 2005 (EP) 05104792.6
Jun. 2, 2005 (EP) 05104794.2

(51) Int. Cl. G09F 19/00; A47B 97/00

(52) U.S. Cl. 40/428; 312/204

(57) ABSTRACT

A simulated fireplace comprising a flat screen display panel mounted within a frame is described. The panel is configured to display at least one image sequence of a fire, the image sequence being stored on a memory device and the fireplace being characterised in that it further includes a single glass sheet mountable to the front of the frame and having a footprint greater than that of the panel. Desirably, the panel is provided device may be a flash memory card, which is receivable in a receiving slot on a side panel of the frame.

### FIELD OF THE INVENTION

The present invention relates to fireplaces and in particular to a simulated fireplace that provides for the electronic display of a fire using a flat screen display panel.

### BACKGROUND

A fireplace is a traditional structure provided in most homes. Traditionally the fireplace has included a hearth that is set into a wall and which provides a base for a combustible material such as coal or wood. The burning of the material requires an exhaust flue so as to enable the generated gases to be transferred out of the room. The burning of the fire generates heat, light and sound.

Although traditionally provided in a home for the generation of heat, it has become more and more common for the other features of the fire—the light and sound element—to the be the driving motivators behind the provision of the fire. With the development of central heating, the main heating of the home is now provided through radiators or the like and the fireplace simply become a focal feature to the room in which it is in.

With such developments the need to burn a combustible material has diminished and electric fireplaces which provide for a simulation of the fire effect have become more and more common. Examples of such fireplaces include those described in EP0348137 which is co-assigned to the present assignee. In this patent an optical display apparatus comprising a non-isotropic holographic diffusing screen, a light source for projecting a pattern of light onto the screen, and a reflector is described. The screen has the property of being substantially transparent, except for light from the source which is diffused, diffracted and then reflected back through the screen by the reflector. The screen is substantially transparent to the reflected light. The apparatus can be used as a decorative display, for advertising purposes and in a flame effect fire. The pattern of light projected from the source is configured to achieve the desired optical effect. Although this was an improvement on the simulated fires that came before, it suffers in that it as it is a mechanical arrangement it always provides the same fire effect.

Modifications to such simulated fireplaces include those described in US20030201957 which describes a fireplace incorporating a flat panel display screen that is driven by a controller. The fireplace includes storage media that enables the storage of images of a fire and a controller that can be used to vary the image that is displayed on the display panel. It also describes the provision of an auxiliary port for connection of a DVD player or the like for delivering DVD content to the display panel. The auxiliary port is also described as being configurable for coupling to a LAN, WAN or the Internet to enable the provision of new images to the storage media for subsequent display. The electronic complexity of this fireplace more resembles that of a conventional computer or television with a flat screen display. It is in essence a computer that is specifically tailored for displaying fires. By providing for the processing and control of the images using an incorporated controller this arrangement suffers in its complexity and resultant cost. However, such complexity is required when one considers the size of the images that are required for display and if different burn effects are required for display each of these much be stored separately. The storage capabilities of the storage devices will restrict the volume of data images that may be stored or associated with the fireplace.

Another problem with the fireplace of US20030201957 arises in the location of the display panel behind two doors. Due to the configuration of the doors, although they may include glass through which the display may be seen, the glass is mounted within a frame that occludes a portion of the viewable image. However this configuration is suitable for, and in fact designed for, the intended location of such a fireplace which is intended to replace a traditional fireplace in the opening normally provided in buildings for same. In this way the fireplace of US20030201957 resembles a solid fuel boiler with the doors defining an internal cavity which would have traditionally been where the fuel would have been burnt in an enclosed area. The controls are all provided on a simulated hearth. In this way the fireplace is a large unit which is not suitable for self standing or indeed as a wall mounted unit.

There is therefore a need to provide a simulated fireplace that can provide a plurality of images of different types yet does not require the same level of complexity that is required from the prior art arrangements. Another problem that needs to be addressed is how to provide a simulated fireplace that presents an obstructed view of the displayed image in a manner directly suited to the type of image being displayed. A further problem is how to provide an unobtrusive wall mounted simulated fireplace.

### SUMMARY

These and other problems are addressed by a simulated fireplace in accordance with the present invention. Such a fireplace includes a flat panel display that can be used to display images of fires thereon. The panel is mounted within a support frame that provides a mount for a single sheet of glass that has a footprint greater than that of the display panel. When mounted to the frame images displayed on the panel are viewable through the sheet. The sheet is desirably smoked such that when the display is not activated the display panel is not visible through the glass, yet when it is activated the backlit effect of the display provides an image of a fire whose quality is enhanced by viewing it through the glass.

The glass may have controlled levels of transparency with the levels being controlled by activation of a suitable current or voltage through the glass.

The images are desirably retrievable from a storage media provided in the form of a removable flash memory card. By providing such a memory card that can be easily inserted and removed from the fireplace it is possible, in accordance with the teachings of the invention to store different images or sequences of images on different memory flash cards and when a specific image type is required to simply allow the user to replace the memory card that is being accessed by the display with a different one.

Accordingly, a first embodiment of the invention provides a simulated fireplace according to claim 1. Advantageous embodiments are provided in the dependent claims.

These and other features of the invention will be better understood with reference to the following drawings.

### BRIEF DESCRIPTION OF THE DRAWINGS

FIG. 1 is a perspective view from the front and side of a simulated fireplace in accordance with the teachings of the invention.

FIG. 2 is a perspective view from the front and side of a simulated fireplace in accordance with another embodiment of the invention.

FIG. 3 is a perspective view from the front and side of a simulated fireplace in accordance with another embodiment of the invention.

FIG. 4 is a view of from the rear of the fireplace of FIG. 2 with the glass sheet removed, showing how the fireplace may be hung from a wall.

FIG. 5 is a view from the front of the fireplace of FIG. 4 showing an exemplary type of memory device that may be used.

FIG. 6 is a view from the rear of the fireplace of FIG. 5, with the back cover removed so as to show some of the electronic control components which are illustrated in schematic form.

FIG. 7 is a view from the front and side of a further embodiment incorporating a dual panel arrangement.

### DETAILED DESCRIPTION OF THE DRAWINGS

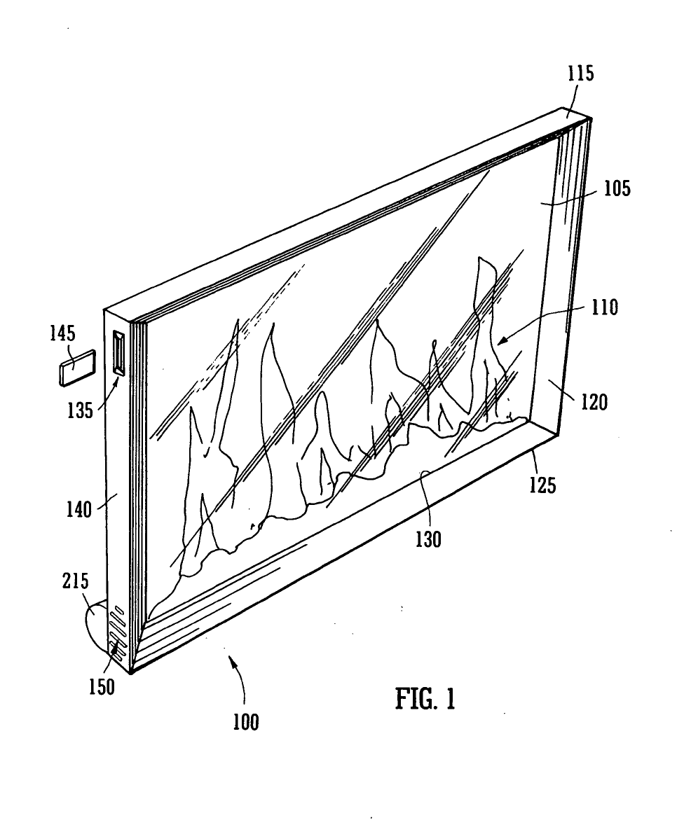

FIG. 1 shows a simulated fireplace 100 in accordance with the teachings of the present invention. The fireplace 100 includes a flat panel display screen 105 which is configured to display images of a burning fire 110. The display may be selected from one of a variety of different flat panel display types such as plasma screens, liquid crystal displays (LCD's) or the like as will be well apparent to those skilled in the art. The display is mounted within a frame 115, that provides a tapered surface 120 from a front edge portion 125 which is distally located from the screen to a rear edge portion 130 which is coincident with the screen. The frame defines the overall depth of the fire. The tapering effect is chosen so as to increase the apparent depth of view of the displayed images on the screen 105. A glass sheet whose footprint is larger than that of the display panel is mountable to the front edge portion of the frame such that once mounted that the image 110 is viewable through the sheet. Once mounted the area between the tapered surface 130 of the frame 125, the display panel 105 and the sheet 135 defines an air volume 140. This volume is desirably vented through the provision of vents 145 provided in upper 150 and lower 155 surfaces of the frame. The depth of the tapered surface is typically of the order of up to about 12 cm. The volume of air is therefore quite small and can become easily heated through both the output of the flat panel and, as will be described later, through active heat elements of the fireplace.

In a preferred embodiment of the invention the glass sheet 135 is provided as a smoked glass sheet. The smoking of a glass sheet is a technique that is used during the manufacture of the glass and achieves a darkening of the glass. Using such glass within the context of the provision of a simulated fireplace is advantageous for at least two reasons. Firstly, when the image is not being displayed, the darkness of the glass occludes the frame and display panel behind. As such if the fireplace is mounted to a wall, all that is visible is a darkened glass sheet, which is aesthetically pleasing. Of course the configuration of the glass could also be altered to provide for different shapes. Once the display is effected, the flame effects 110 are visible through the smoked glass but are tempered somewhat by the colouring of the glass. It has been found by the present inventors that despite it appearing initially counter intuitive to increase the absorption of light in light passing through a glass screen in front of an image displayed using the high light emission characteristics of a flat-panel display, that the smoked effect selectively absorbs light in the wavelength ranges most suited to the light emitted by a fire, and as such the effect of the fire is enhanced.

Other colouration effects that could be utilised with the glass sheet is a partial mirroring of the first surface. The mirroring may optimally be chosen to such a level that when the display is off that the mirror effect is complete such that a user to the front of the fire gets a full reflection of their image. When the display is turned on, the light emitted by the display is then visible through the front sheet. Such an embodiment is particularly useful for a bedroom or bathroom installation where the non use of the fire enables a user to avail of a mirror, thereby providing a dual functionality.

In combination with the visual effects, the fireplace of the present invention may additionally provide for the generation of sound effects consistent with the displayed image through one or more speakers 160.

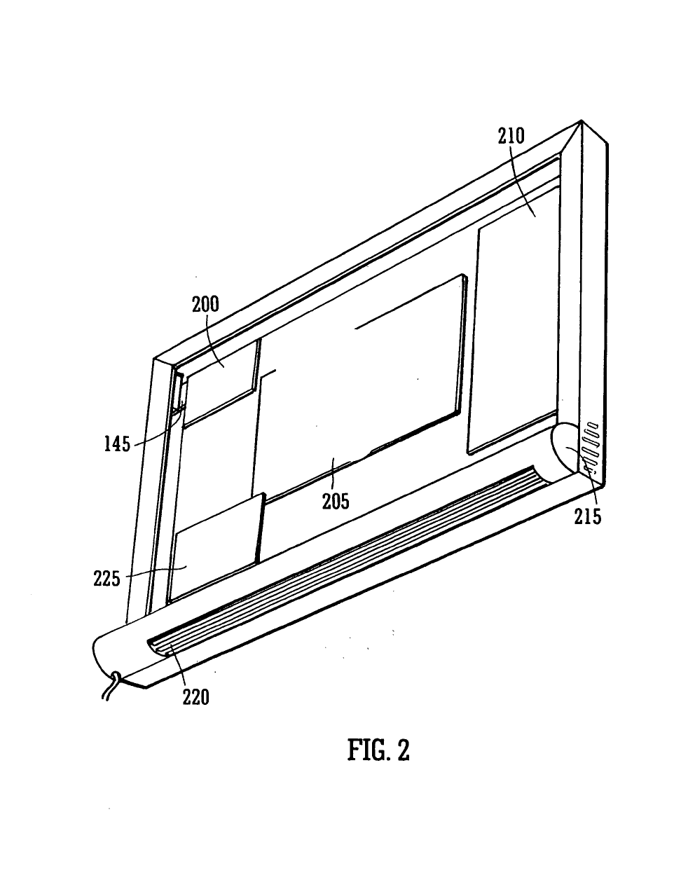

FIG. 2 shows a modification to the fireplace of FIG. 1 with the footprint of the glass sheet used being smaller than that of FIG. 1. In this embodiment a glass sheet 200 is provided that incorporates a thin oxide resistive layer which when a current is passed through heats up. Such heating will enhance the simulation of the fire effect in that a user coming close to the fireplace will be able to feel warmth emanating from the fire. The temperature chosen should typically be not so great as to cause burning to a user touching the glass. As mentioned above, the heating of the sheet may be achieved by providing the sheet with a thin oxide resistive coating of a desired pattern and passing a low current through the glass. Two contacts 205a, 205b may be coupled to the controller of the fireplace and when activated generate a current path through the oxide layer. The passing of the current effects heating of the glass. The use of the thin oxide layer is advantageous in that there is no requirement for a visible pattern of heating elements to be provided on the surface of the glass, which although would provide for heating would also occlude a portion of the visible image being displayed on the panel behind. However where the sheet and the display panel do not coincide it is possible to utilise a different type of heating element such as a self adhesive low wattage heating element that may be adhered to portions of the glass sheet outside the footprint defined by the display panel.

Of course by heating the glass it is possible that the air volume 140 will also heat and this heating could damage the screen 105. The present invention addresses this by providing a series of air vents 145 in the top 150 and bottom 155 of the frame. In accordance with convective principles, air will circulate through the vents thereby cooling the air volume and obviating the possibility of the screen becoming damaged.

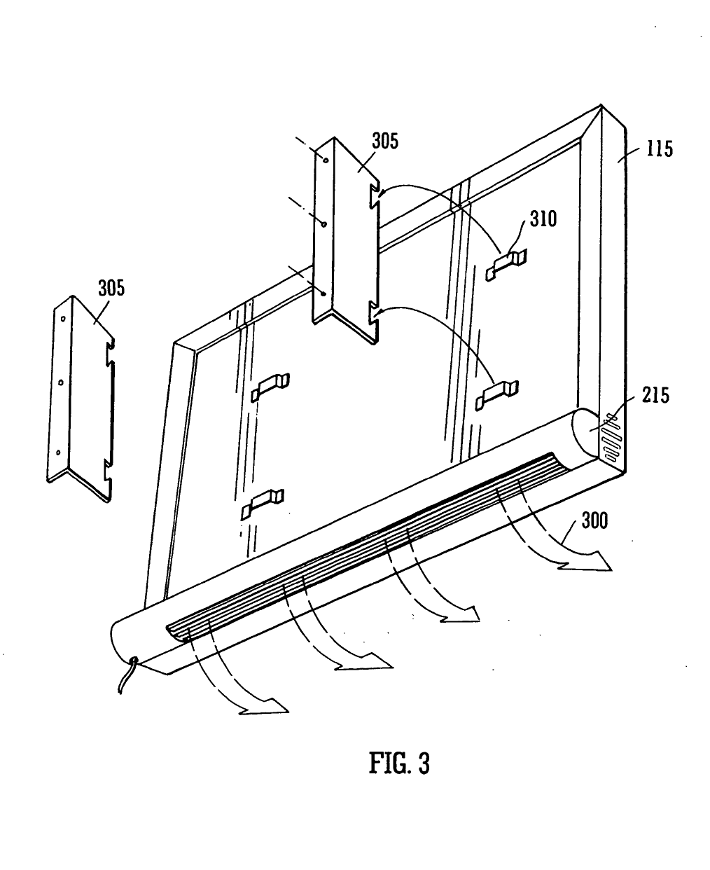

FIG. 3 shows yet a further embodiment of the invention with a glass sheet 300 of yet a smaller footprint being used. The footprint is still however bigger than the footprint of the display panel 105.

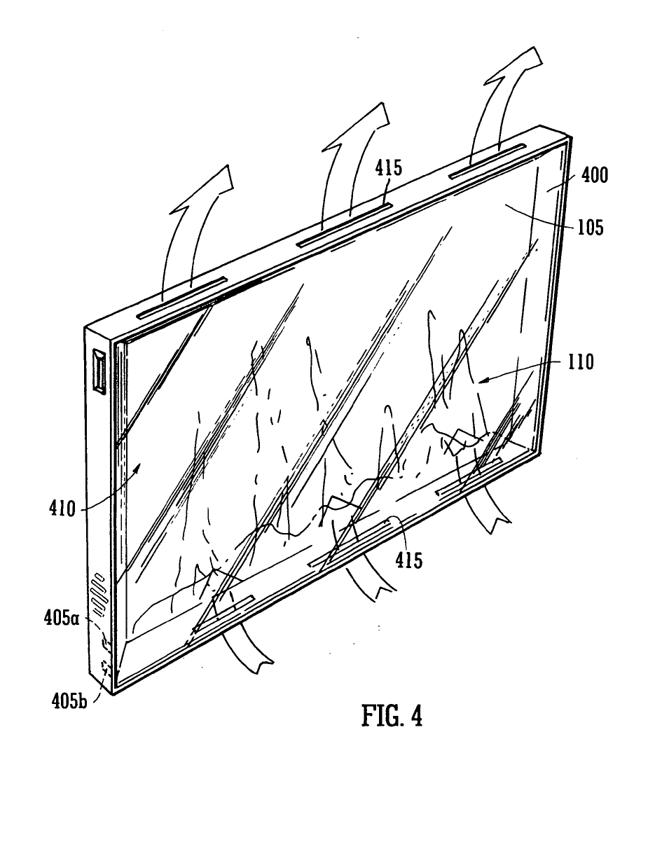

As part of the overall simulated fire effect, the simulated fireplace of the present invention may include one or more active air heating elements. As shown in FIGS. 4 to 6, a fan heater 415 may be included. The heater may be of the type known as a cylindrical drum heater with a number of blades 420 arranged circumferentially about an axis. The heater is typically provided at the rear of the frame, so that it is not visible from the front, with its axis being parallel to the bottom 155 of the frame such that rotation of the drum will cause air to be blown downwardly under the frame. A user facing the front of the frame will therefore experience heat passing upwardly in front of the screen—giving the effect that the fire displayed on the screen is generating heat. Such movement of air 430 is shown in FIG. 4, where it will be seen that the dimension of the drum heater is desirably such that the hot air is generated across the entire length of the frame. A vent could also be provided in a portion of the glass sheet to enable the generated hot air to pass directly through the area defined by the sheet.

FIG. 4 also shows a series of mounting brackets 405 which may be used to mount the frame 115 to a wall. With such a simulated fireplace of the present invention it will be appreciated that as there are no noxious fumes generated, it is not necessary for the fireplace to be placed in a chimney with a flue. It will however be appreciated that if the circumstances require such an installation that the simulated fireplace of the present invention could easily be placed within such a traditional recessed area, with the dimension of the frame increased to as to create the impression that the fireplace is integral with the hearth. In the example of FIG. 4 however, it will be appreciated that the use of mounting brackets that engage with receivers 410 on the back of the frame and which can be secured to a wall using screws or the like, that the present invention obviates the need for a building to be built with a fireplace in order to have such a simulated fireplace. This lack of a fireplace is becoming more and more prevalent in today's building environment, and heretofore the owners of such buildings have been unable to have a fireplace or indeed to move it around their room as the need arises. In the view of FIGS. 4 to 6 it will be noted that the glass sheet is not visible. Desirably, the sheet is removably mountable to the front portion of the frame. As such it is easier to mount the frame to a wall and then remount the sheet once the frame is securely attached. Of course, it will be appreciated that the specific L-shaped mounting bracket is exemplary of the type of mounting arrangement that could be used and any suitable mounting means that enables a mounting of the fireplace to a wall would be suitable in the context of the present invention.

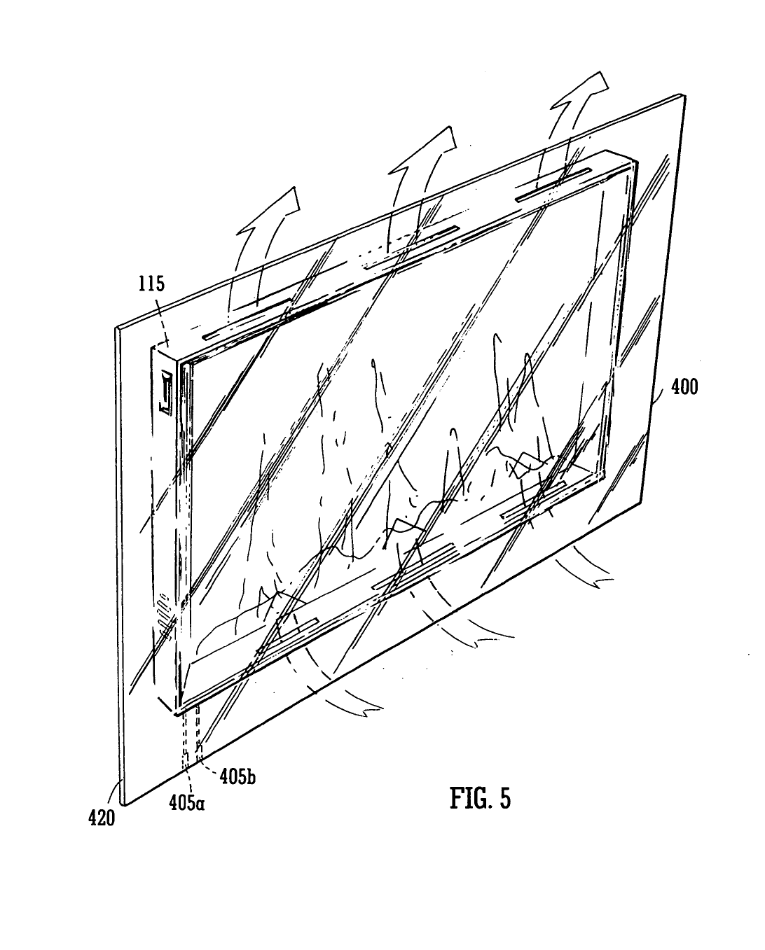

FIG. 5 shows a further modification to the frame of the fireplace of the present invention. A slot 535 is provided on a side wall 540 of the frame 115 and is dimensioned to receive a memory card 545. The memory card is desirably of the type known as a flash memory card—such as those for use in digital cameras and known as Secure Digital (SD), CompactFlash (CF), SmartMedia (SM), Memory Stick (MS), MultiMediaCard (MMC), xD-Picture Card (xD) and the like. Such memory cards are typically provided with a total memory capacity of about 32 MB to about 2 GB. The provision of the slot on a side surface of the frame means that it is not readily visible to the user in front of the fire but is easily accessible by a user wishing to access the memory cards which store the images so as to change them. There is no requirement for the user to access an interior portion of the frame to get access to this memory slot so change of memory cards is a very easy exercise.

In accordance with this embodiment of present invention an image of a fire is recorded using digital video equipment and then edited to a suitable format for storage on the memory card. The editing may include the cutting of a longer image into a shorter frame and then the stitching of that selected frame to a form a video sequence that repeats the selected frame for a specified duration. By providing this editing off-line it is possible to avail of highly efficient image editing software so as to provide the total video sequence as one without any perceptible stutters or pauses between frames. Once a video sequence of desired length has been selected, it is then stored on the flash card in a suitable format—typically one defined by the MPEG standards. It will be apparent to those skilled in the art that the longer the recorded sequence is, the more memory it occupies on the memory card.

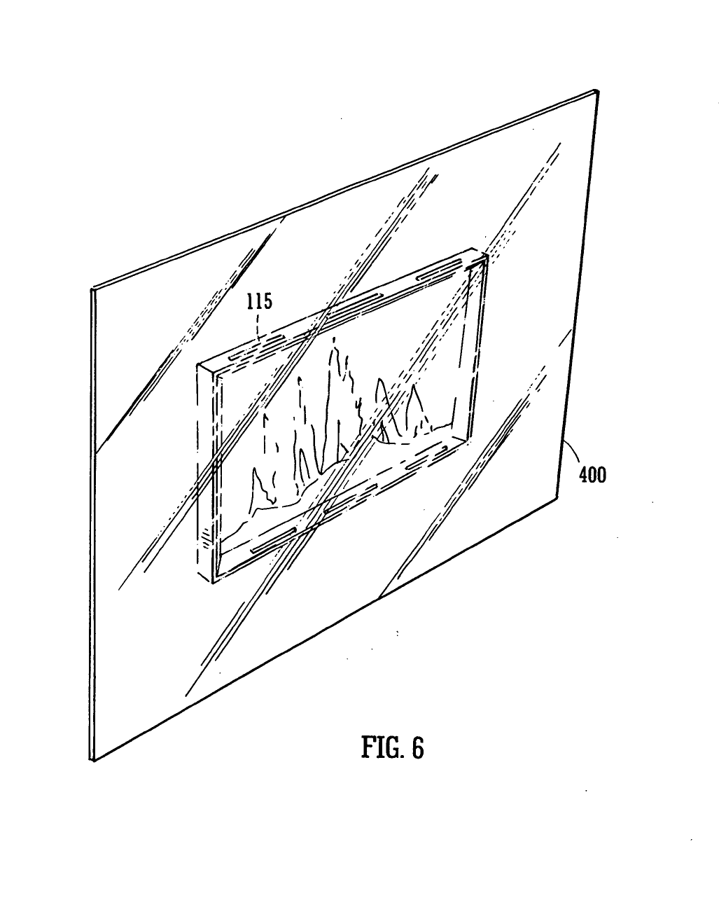

FIG. 6 is a view from the rear of the fireplace with the back cover removed to as to show internal electrical components which are illustrated in schematic form as the specifics of their operation will be apparent to the person skilled in the art. The memory card 545, once inserted into the slot 535 on the side of the frame is received within a card reader circuit 600. The card reader 600 is in electrical communication with a controller 605 which is communicatable with a user interface 610. The user interface may include a remote control interface to enable a user to control the operation of the fireplace using a remote control. Once the user selects a desired function that is communicated from the user interface 610 to the controller 605 which then selects the stored image from the memory card and displays them on the screen. The desired function may include one or more of user controlled parameters such as sound level, light intensity, length of sequence and the like. If the selected length of sequence is greater than that stored on the flash memory card, then at the end of the stored sequence, the controller will effect a loop back to the beginning of stored sequence and display the video from the beginning.

It will be appreciated that such looping typically results in a momentary pause of the image, which may be perceptible to a person viewing the display. As such it is desirable that the stored sequence is as long as possible so that the number of loops required is kept to a minimum. However as discussed above, the limiting factor to the duration of video that may be stored is the memory capacity of the flash card. Although flash cards of differing memory capacities are available, the cost associated with cards of the largest capacity can be prohibitive. There is therefore a trade off between length of sequence storeable and the cost of providing such a card to effect that storage. There is a further trade-off if the screen is to be used with more than one image type. For example the display of a coal fire will require a different image sequence to that of a log fire, and a raging fire is different to that of dying embers. The present invention addresses this problem by enabling the storage of different image sequences on different memory cards and then enabling the user to simply interchange the memory cards to achieve the display of the desired images. In this way each memory card can be used to store the images in the preferred format and for the longest sequence and using the least compression—the only constraining factor being the size of card utilised. It also means that the card used for storage can be optimally selected depending on the volume of data required for storage on that card. For example certain fire types may require a limited time sequence and can therefore be displayed on a card of memory capacity of 32 MB whereas others will require 2 GB. The ability to enable a user to interchange cards as desired by the user, means that the user has choice with regard to the amount that they wish to spend on any one card—as the cost is very much dependent on the memory capacity of the card. It will be apparent that if a user selects a large memory card that the volume and quality of data will be greater than if the user selected a memory card of lesser capacity. In order to enable the user to easily change the memory cards as desired, the simulated fireplace of the present invention provides for the receiver slot 535 to be easily accessible to the user, typically provided on a side portion of the frame 115 such that the card is inserted in a plane substantially perpendicular to that at which the display is viewed.

In a further modification to that heretofore described an additional permanent storage device may be included within the frame and which is configured to interface with the removable memory flash card. The use of two separate types of memory storage devices in combination with one another is advantageous in that the easily removable card can be inserted or removed at will to change the images being viewed whereas the second card can provide a local caching of the image sequence, thereby enabling a buffering of the image and allowing for longer sequences to be displayed without visible delays. Furthermore with two memory devices it is possible to obviate the possibility of total data loss if one of them fails.

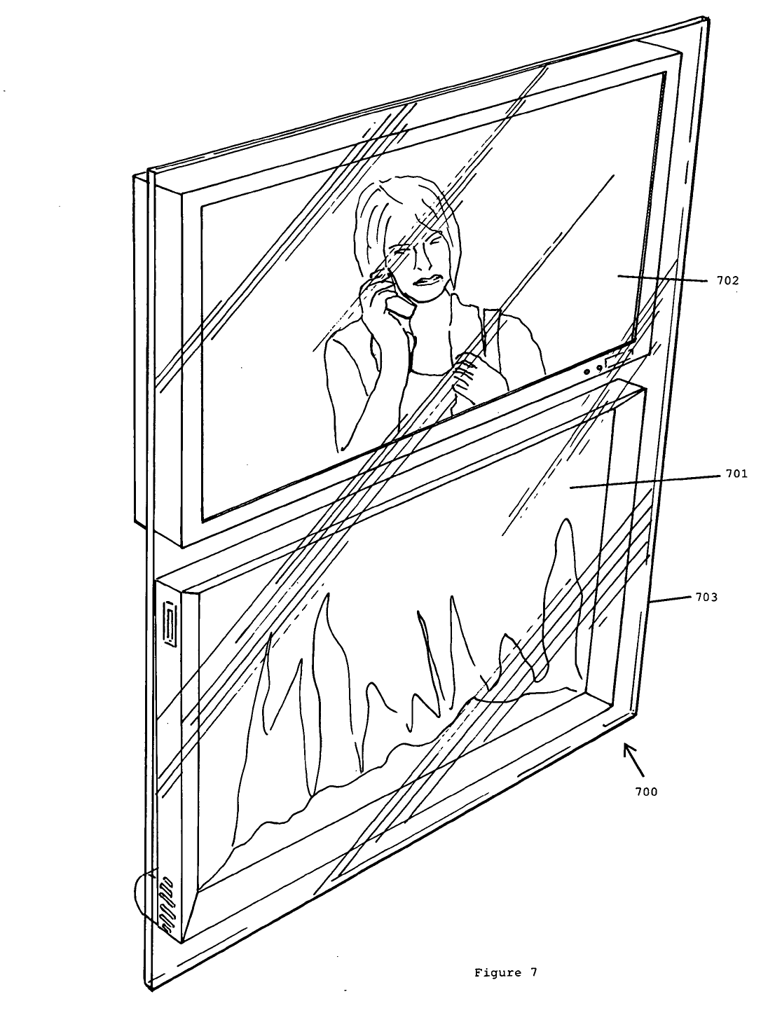

FIG. 7 shows a further modification to the fireplace hereinbefore described. In this dual display embodiment 700, first 701 and second 702 displays are provided, each being located behind the same sheet 703 which has a footprint greater than the footprint of the combined first and second display panels. In the illustrated embodiment the two panels are arranged in a stack arrangement with the first panel configured to interface with an external broadcast service such as a TV or Cable network so that a viewer can use the display panel to watch television programmes or the like. The second display panel provide a fire. In this way the viewer can locate the fireplace in a portion of the room and get the aesthetics of watching a fire while enjoying the broadcast television program. Such a unit could be provided as a wall mounted arrangement or could indeed be provided a free standing model. Although shown in the illustrated embodiment as a vertical stack it will be appreciated that the two displays may be arranged beside one another equally well.

It will be understood that a simulated fireplace that utilises a removable storage device allows for the storage device being easily inserted and removed by a user from the fireplace. By providing such a fireplace it is possible for the user to have a plurality of storage devices, each having different images or image sequences stored thereon. In circumstances where it is not desired to have the fireplace acting as a fireplace it is possible for the user to display other images or sequences of images—such as for example an aquarium effect. At certain times of year it will be possible therefore for the user to use the apparatus of the present invention to present a simulated fireplace whereas other times it could be used to display non-winter specific image sequences.

It will be further understood that where the apparatus is provided with a smoked sheet to enhance the effect of the normally displayed fire, that the smoked effect may be disadvantageous in the viewing of other images. The present invention provides for this in that certain embodiments may incorporate smart glass, glass where the opaqueness may be controlled by application of a voltage. Such glass is known in office environments where on application of a suitable voltage the glass can be turned completely opaque. The use of such glass where the level of transparency can be controlled may be used to provide a optimal degree of transparency for the image being viewed. In such circumstances, the level of transparency may be controlled by a user manually or indeed a certain memory card may have a level associated with it and when that memory card is inserted that the controller activates the correct level of transparency for that card.

Control of the simulated fireplace of the present invention may be achieved using direct controls provided on the frame or by providing a remote control which can be activated by the user. The provision of such controls will be well known to those skilled in the art and the specific implementation will not be described here.

The words comprises/comprising when used in this specification are to specify the presence of stated features, integers, steps or components but does not preclude the presence or addition of one or more other features, integers, steps, components or groups thereof.

1. A simulated fireplace comprising a flat screen display panel mounted within a frame, the frame defining the external dimensions of the fireplace, the panel being configured to display at least one image sequence of a fire, the image sequence being stored on a memory device receivable within the fireplace and wherein the fireplace includes a single sheet mountable to a front portion of the frame, the sheet having a footprint greater than the footprint of the display panel.

2. The fireplace of claim 1 wherein the memory device is a removable flash memory card, the frame incorporating a receiving slot for the memory device provided on a side panel of the frame, the receiving slot being positioned within the frame at a location which is easily accessible by a user such that the user can easily insert and remove memory cards as desired.

3. The fireplace as claimed in claim 2 wherein the receiving slot is provided in a side portion of the frame such that the card is inserted into the frame in a direction substantially perpendicular to the orientation of the display panel.

4. The fireplace as claimed in claim 1 further including a heating element.

5. The fireplace as claimed in claim 4 wherein the heating element is a fan blower located at a rear portion of the frame and configured to blow air around a lower portion of the frame such that the air passes upwardly in front of the display panel.

6. The fireplace as claimed in claim 1 wherein the sheet is provided at a distance of about 12 cm from the front of the display panel, the provision of the sheet defining an air volume between the panel and the sheet.

7. The fireplace as claimed in claim 1 wherein the sheet is removably mountable to a front surface of the frame.

8. The fireplace as claimed in claim 1 wherein the sheet is heatable.

9. The fireplace as claimed in claim 8 wherein the sheet is coated with an resistive oxide coating and a current is passed through that coating so as to provide for a heating of the sheet.

10. The fireplace as claimed in claim 6 wherein the frame includes a plurality of vents dimensioned to allow air to circulate within the air volume.

11. The fireplace as claimed in claim 1 wherein the sheet is a glass sheet whose level of transparency is controllable on application of a voltage through the sheet.

12. The fireplace as claimed in claim 1 further including at least one mounting bracket, the mounting bracket enabling a mounting of the fireplace to a wall.

13. The fireplace as claimed in claim 1 wherein the choice of memory card inserted by the users depends on the image sequence that the user wishes to view.

14. A fireplace as claimed in claim 1 further including at least one sound speaker, the speaker being configured to provide sound effects associated with the image of the fire being displayed on the panel.

15. A fireplace as claimed in claim 1 wherein the sheet of glass is a sheet of smoked glass.

16. A fireplace as claimed in claim 1 including a second memory device, the second memory device being located within the frame of the fireplace and being inaccessible from outside of the frame, the second memory device being interfaceable with the first memory device.

17. A fireplace as claimed in claim 1 further including a second display panel, the second display panel being mounted below the first display panel in a stack arrangement, the first and second display panels being co-located behind the sheet.

18. A fireplace as claimed in claim 1 further including a second display panel, a display portion of the second display panel being co-planar with a display portion of the first display panel, the first and second display panels being arranged beside one another and behind the sheet.

19. A fireplace as claimed in claim 18 wherein the second display panel is configured to be interfaced with an external broadcasting service, such that images generated and broadcast by the external broadcasting service may be displayed on the second display panel.

20. A fireplace as claimed in claim 19 wherein the first and second display panels are configured to enable a simultaneous display of images on both panels.

21. A fireplace as claimed in claim 20 wherein the images displayed on the first panel are different to those displayed on the second panel.

22. A fireplace as claimed in claim 1 further including a heating element adhered to the screen.

23. A fireplace as claimed in claim 22 wherein the heating element is a low wattage heating element and is adhered to an inner surface of the screen.

24. A fireplace as claimed in claim 23 wherein the heating element is adhered to portions of the screen that do not overlap with a display panel.

25. A fireplace as claimed in claim 22 wherein the heating element is provided with a self-adhesive surface to enable easy adhering of the element to the screen.

26. A fireplace as claimed in claim 1 further including a fan heater arranged to provide for a circulation of warm air emanating from the fireplace.

27. A fireplace as claimed in claim 26 wherein the fan heater is provided behind a grill provided in the sheet.

28. A fireplace as claimed in claim 27 wherein the grill is located at a lower portion of the fireplace screen, so as to blow heated air from a bottom portion of the fireplace.

29. A fireplace as claimed in claim 1 being configured to be mounted on a wall.

30. A fireplace as claimed in claim 1 wherein the sheet is provided with at least a partial mirrored coating.

31. A wall mounted bathroom cabinet incorporating a fireplace as claimed in claim 30.
